(19) United States
(12) Patent Application Publication
(10) Pub. No.: US 2005/0150332 A1
(43) Pub. Date: Jul. 14, 2005

(54) Toilet ballcock valve wrench

(76) Inventor: Lynn R. Russell, Mechanicsburg, PA (US)

Correspondence Address: LITMAN LAW OFFICES, LTD, PO BOX 15035, CRYSTAL CITY STATION, ARLINGTON, VA, 22215, US

(21) Appl. No.: 10/755,342

(22) Filed: Jan. 13, 2004

(51) Int. Cl. B25B 13/00

(52) U.S. Cl. 81/125.1

(57) ABSTRACT

The present invention comprises a series of embodiments of a toilet ballcock valve wrench, configured for use on at least one of the retainer nuts and/or supply line nuts used conventionally in a toilet tank ballcock valve installation. The present wrench may be single or double ended, with double ended embodiments including heads adapted for use on the ballcock valve retainer nut and smaller supply line nut, or on different configurations of the retainer nut. The ends may have axial and/or planar offset, or may be straight, as desired. The present wrench in any of its embodiments may be formed as a flat metal stamping or otherwise formed (stamped, forged, etc.) of metal, or may be cast or otherwise formed of a plastic material for lighter duty work and/or limited use, if so desired. The plastic embodiments each include a series of ribs and central webs, for sufficient strength.

### BACKGROUND OF THE INVENTION

1. Field of the Invention

The present invention relates generally to hand tools and the like, and more specifically to a series of embodiments of wrenches configured particularly for use on the nuts and fittings conventionally used to secure a ballcock valve assembly in a toilet tank and/or to secure the water supply line to the bottom end of the assembly. The present ballcock valve wrenches may be single or double ended, flat or with planar or angular offset, and/or formed of metal or plastic, as desired.

2. Description of the Related Art

Conventional flush toilets are universally equipped with a ballcock valve, which controls the level of the water in the toilet tank. Such valves are secured through the bottom of the tank, and are held in place by a specialized, relatively large diameter retaining nut which fits around the threaded lower end of the ballcock valve tube. Such ballcock valve attachment nuts may take many forms, from ribbed external surfaces for plastic (PVC) components to more conventional hexagonal faces, and may even have opposed flanges or wings to facilitate their manipulation and tightening on the end of the ballcock valve tube.

In addition to the retaining nut used to secure the ballcock valve assembly to the bottom of the tank, other fasteners must be provided to secure the water supply line to the bottom of the ballcock valve tube and to the shutoff valve to which the water line is connected. The supply line tube is universally of a smaller diameter than the diameter of the ballcock valve tube, and the supply line nuts are thus of a smaller diameter than the ballcock valve retainer nut. The supply line nuts may have various different configurations similar to those of the ballcock valve retainer nut, but are generally hexagonally shaped.

As can be seen, a plumber or other person who has cause to remove and replace a toilet ballcock valve, must have appropriate wrenches of the proper sizes and configurations on hand in order to accomplish the task. Heretofore, the repair person has been required to have at hand at least two wrenches, one for the relatively large diameter and configuration of the ballcock valve retaining nut, and another to fit the smaller diameter supply line nuts. While innumerable double ended combination wrenches have been developed over the years, the two different wrenches nearly always comprise an open end and a box end of the same diameter. The present ballcock valve wrench responds to this problem by providing a double ended combination wrench in which each end is configured to fit either a ballcock valve retaining nut or a water supply line nut, thereby providing all of the wrenches needed in a single tool. The present invention includes various embodiments of such a tool, as well as single ended embodiments adapted for only a single fastener configuration.

A discussion of the related art of which the present inventor is aware, and its differences and distinctions from the present invention, is provided below.

U.S. Pat. No. 3,354,757 issued on Nov. 28, 1967 to David W. Grimm et al., titled “Spline Wrenching Configurations,” describes a box end (i.e., closed end) wrench for use on splined fasteners, but which may also be adapted for use on hexagonal or twelve point fasteners as well. Aside from the fact that the internal splines have equally spaced ridges and valleys, thereby making their spacing unsuitable for use on a ridged ballcock valve retaining nut, the Grimm et al. box end wrench cannot be installed over the continuous length of the water supply line. An open end wrench is necessary in the environment of the present invention.

U.S. Pat. No. 3,908,489 issued on Sep. 30, 1975 to Keiichi Yamamoto et al., titled “Fastener Driver,” describes a wrench having a series of inwardly oriented ribs, for use with a mating fastener head having a corresponding series of inwardly oriented channels. The inwardly oriented ribs of the Yamamoto et al. wrench are opposite the arrangement needed for use with ribbed PVC plumbing fasteners. Also, the Yamamoto et al. wrench has a box end (closed) configuration, which cannot be used on fasteners installed on a continuous length of tubing or the like, as there is no way to place the closed wrench head around the fastener in such a continuous run, nor to remove such a closed wrench head from the assembly after securing the fastener(s).

U.S. Pat. No. 4,562,758 issued on Jan. 7, 1986 to Allan D. Stirling, titled “Valve And Faucet Handle Tools,” describes a box end type wrench having a series of axially oriented projections extending from the circumferential wall, for engaging the wings extending from a correspondingly configured faucet handle. The opposite side of the wrench includes a series of overlapping channels and depressions therein, for fitting other types of faucet handles or the like. None of the various handle engaging elements of the Stirling wrench appear to be suitable for engaging hexagonal or ribbed retaining or supply line nuts, and the closed end configuration of the Stirling wrench renders it incapable of being used on such continuous run assemblies in any case.

U.S. Pat. No. 4,738,169 issued on Apr. 19, 1988 to Richard M. Wyka, titled “Wrench,” describes a pair of different embodiments of a combination wrench formed of plastic. While some of the embodiments of the present wrench superficially resemble the Wyka wrench, it is noted that only one of the Wyka wrench embodiments includes an open end wrench head, and then only on one end of the double ended combination. Each of the Wyka wrenches has a hexagonal configuration, which is not suited for use with ribbed or winged fasteners often used in the installation of toilet ballcock valves and their water supply lines. It is also noted that the Wyka wrenches are asymmetrical in cross section, having their lateral webs disposed to one side of the wrenches rather than being centrally disposed across the ribs, as in the present wrench to equalize stresses therein.

U.S. Patent Publication No. 2003/172,782, published on Sep. 18, 2003, titled “Split Socket Tool,” describes a large number of embodiments of wrenches, pliers, etc., with the common theme being relatively wider, axially offset jaws with each of the gripping ends or jaws of the devices. FIG. 7 of Saunders illustrates a combination wrench having opposed open ends, with one of the ends comprising a flare nut type wrench in which the distal opening between the jaws is narrower than the maximum internal diameter of the jaws. While the FIG. 7 embodiment of Saunders has a number of teeth corresponding to a twelve point box end wrench, the Saunders FIG. 7 embodiment cannot be used with ballcock valve retaining nuts or supply line nuts having conventional configurations.

U.S. Design Patent No. 420,263 issued on Feb. 8, 2000 to Chao Wei, titled “Wrench,” illustrates a design for a combination wrench having an open end with a configuration much like that of the FIG. 7 embodiment of the Saunders '782 patent Publication discussed immediately above. The same points noted in that discussion, are seen to apply here as well.

Finally, U.S. Design Patent No. 461,107 issued on Aug. 6, 2002 to Edmond L. Pitt, titled “Wrench For Fastener,” illustrates a design for a combination wrench having opposed open and box ends configured for use with ribbed nuts or the like. The device can only be used on one type and size of nut, as both ends are apparently of identical size and differ only in their closed and open end configurations. The closed end cannot be used to secure fasteners along a continuous run of pipe or the like.

None of the above inventions and patents, taken either singly or in combination, is seen to describe the instant invention as claimed. Thus, a toilet ballcock valve wrench solving the aforementioned problems is desired.

### SUMMARY OF THE INVENTION

The present toilet ballcock valve wrench in its various embodiments provides a single tool, or at most a pair of tools, which are capable of disassembling and securing all of the fasteners and fittings associated with the installation and repair of the ballcock valve of a conventional flush toilet. The present wrench may comprise single or double end embodiments having a ballcock valve retainer nut wrench on one end and a supply line wrench on the opposite end, or may provide wrenches for different retainer nut configurations on the opposite ends. Alternatively, the present invention may comprise a single end wrench configured for use on one or more configurations of the ballcock valve retainer nut. The present wrench may be provided in straight or angularly offset variations, and/or flat or planar offset variations, as desired. In addition, the present wrench in any of its various embodiments may be formed as a stamping or other manufacture from a metal plate or the like, or may be cast or forged of metal, as desired. The present disclosure also includes an alternative configuration of a molded plastic material, for lighter duty work. The plastic embodiments are relatively light, and include stiffening webs and ribs to provide the desired strength.

### BRIEF DESCRIPTION OF THE DRAWINGS

FIG. 1 is a perspective view of a first embodiment of a toilet ballcock valve wrench according to the present invention, showing the adaptability of the two ends to different fittings.

FIG. 2 is a perspective view of a single ended wrench of the present invention, showing various alternatives in broken lines.

FIG. 3 is a perspective view of another double ended combination wrench according to the present invention, showing both planar and axial offset as options.

FIG. 4 is a perspective view of yet another double ended combination wrench of the present invention with axially centered jaws but showing a planar offset variation in broken lines.

FIG. 5 is a perspective view of a single end wrench functionally similar to the wrench embodiment of FIG. 2, but formed of plastic in a pattern of stiffening ribs and webs.

FIG. 6 is a perspective view of a wrench embodiment similar to that of FIG. 5, but including a deeper recess for gripping one wing of a winged fastener.

FIG. 7 is a perspective view of a plastic wrench embodiment having a first head configuration similar to the FIG. 1 wrench and a second head configuration similar to the FIG. 4 wrench.

FIG. 8 is a perspective view of plastic wrench embodiment with a first head configuration similar to the FIG. 6 wrench and a second head configuration similar to the FIG. 7 wrench.

Similar reference characters denote corresponding features consistently throughout the attached drawings.

### DETAILED DESCRIPTION OF THE PREFERRED EMBODIMENTS

The present invention comprises a series of embodiments of a toilet ballcock valve wrench, adapted particularly for the installation and removal of the fasteners conventionally used to secure a ballcock valve assembly in a toilet tank. Such fasteners may have any of a variety of configurations, from ribbed plastic, winged, or hexagonal ballcock valve assembly retainer nuts to generally hexagonal water supply line nuts, generally of smaller diameter than the retainer nuts. With the present invention, a single wrench having a suitable wrench head on each end of the handle or shank, may be used to remove and secure all of the threaded fasteners involved in the project. Alternatively, a pair of single ended wrenches may be used for the supply line and ballcock valve retainer nuts, if desired.

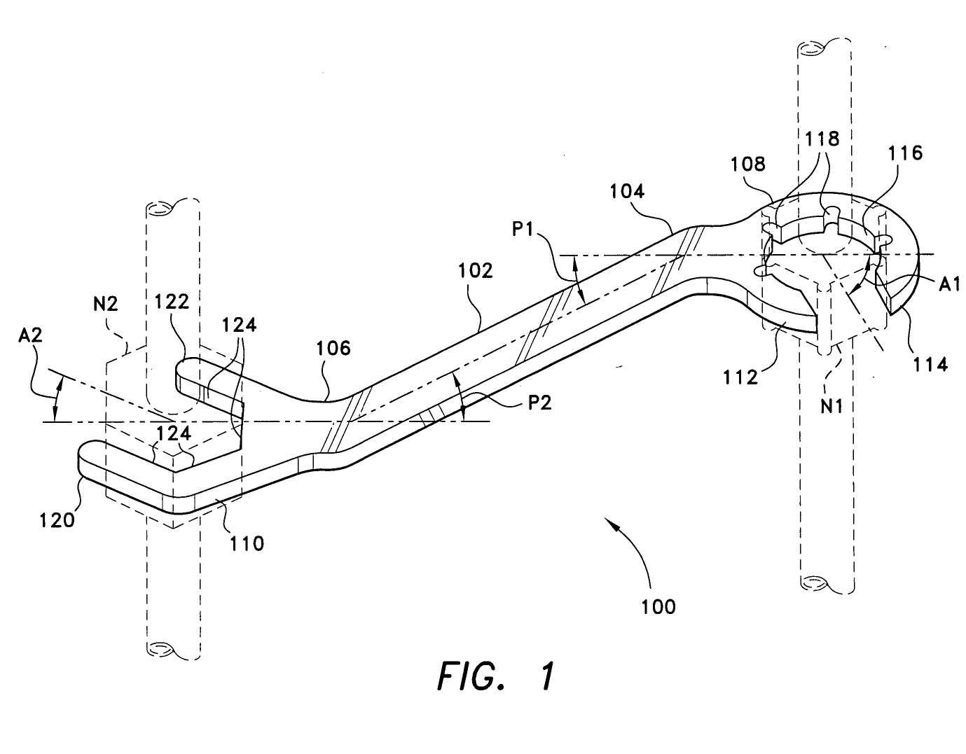

FIG. 1 of the drawings illustrates a first embodiment wrench 100 of the present invention. The ballcock wrench 100 of FIG. 1 comprises a double ended wrench, having a relatively narrow, elongated shank portion 102 with opposed first and second ends, respectively 104 and 106. The first end 104 has a first open-end wrench head 108 extending therefrom, while the second end 106 has a second open-end wrench head 110 extending therefrom. All of the various wrench head and wrench combinations of the present invention are open-ended, in order to pass around a continuous water supply line extending from a water shutoff valve to the lower end of the ballcock valve, as is conventional in such installations.

The first wrench head 108 comprises a pair of opposing jaws, respectively 112 and 114, with the head 108 having a semicircular internal configuration 116 with a series of widely separated, evenly spaced, rounded notches 118 therein. The notches 118 are spaced sixty degrees apart around the semicircular internal passage 116, i.e. to provide a total of six notches around a complete circle in a closed or box end wrench. As the two opposed jaws 112 and 114 define an opening therebetween, fewer such notches 118 are provided around the internal circumference 116 of the wrench head 108. However, the semicircular internal configuration 116 and notches 118 are configured to match precisely with a conventional externally ribbed ballcock valve retainer nut N of corresponding diameter (an exemplary one of which is illustrated in broken lines in FIG. 1). The first wrench head 108 may be formed in any practicable diameter to closely fit a given size of retainer nut N1, as desired.

The opposite second wrench head 110 is also of open end configuration, with a pair of opposing jaws, respectively 120 and 122, defining an opening therebetween. However, the second wrench head 110 has a completely different internal configuration than that of the first wrench head 108, in that it is adapted to fit a conventional hexagonal threaded fitting. The internal configuration of the second wrench head 110 comprises four faces 124 spaced angularly at sixty degrees from one another, to fit precisely about a conventional hexagonal fastener of corresponding diameter, e.g. a water supply line nut N2 of a ballcock valve assembly, as shown in broken lines in FIG. 1.

Generally, the water supply line nut N2 is of a smaller diameter than the ballcock valve retainer nut N1. The size of the second wrench 110 span and corresponding water supply line nut N2 are exaggerated in FIG. 1 and other drawing Figs., although they could be produced to have identical spans or diameters, if so desired. Also, it will be noted that the view of FIG. 1 showing the two ends of the wrench 100 engaged simultaneously on two fittings, is intended merely to indicate the widely differing types of fittings or nuts to which the wrench 100 is adapted. It will be clear that the wrench 100 must have one end free in order to rotate the nut or fastener to which it is applied, and that it will not be applied simultaneously to a fastener at each end thereof, in actual use.

The wrench 100 of FIG. 1 may be formed in a variety of different configurations in addition to providing different diameters or spans for the two wrench heads 108 and 110. It will be noted that the openings of the two wrench heads 108 and 110 are axially offset from the centerlines of their respective wrench heads, as indicated respectively by the axial offset angles A1 and A2 between their respective wrench centerlines and the centerlines of the wrench openings, centered between their respective jaws. Also, the wrench 100 may have a planar offset for either or both ends 104 and 106, as indicated by the planar offset angles P1 and P2 at the respective ends 104 and 106 of the wrench 100. Either, or both, wrench heads 108 and/or 110 may be provided with angular and/or planar offset, or the wrench 100 may be formed in a straight configuration with no offset, as desired.

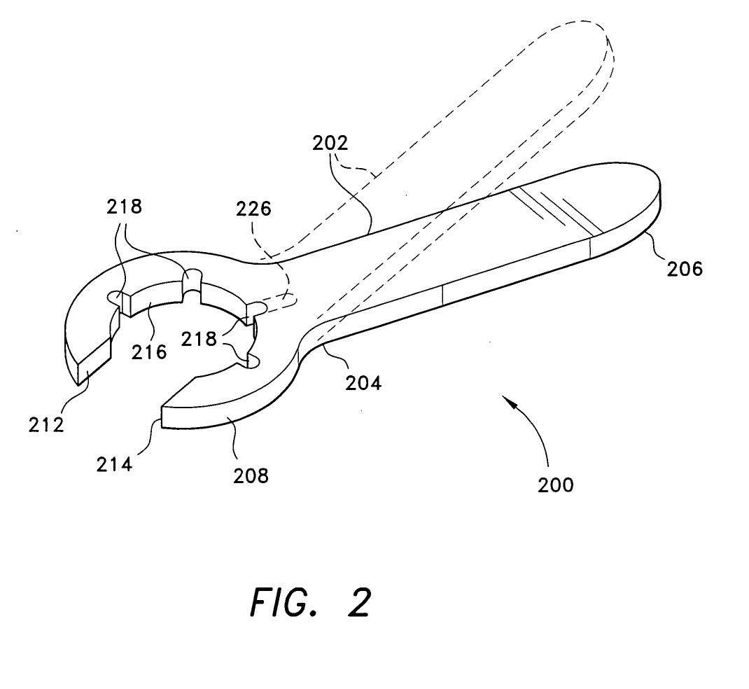

FIG. 2 illustrates a variation upon the wrench 100 of FIG. 1, with the wrench 200 of FIG. 2 having a shank 202 with a first end 204 having a wrench head extending therefrom, and the opposite second end 206 forming a hand grip portion. The single wrench head 208 of the wrench 200 is configured similarly to the first wrench head 108 of the wrench 100 of FIG. 1, i.e., having two spaced apart jaws 212 and 214 defining a semicircular interior configuration 216 with a series of rounded notches 218 formed therein, adapted to fit precisely about the ribbed exterior of a conventional ballcock valve assembly retainer nut. As in the wrench 100 of FIG. 1, the axis of the opening as defined by the jaws 212 and 214 may be aligned with or axially offset from the axis of the shank 202, and/or the wrench head 208 may have a planar offset from the shank 202, as indicated by the alternative position of the shank 202 in broken lines.

Another option is also shown in broken lines in the wrench 200 of FIG. 2, with the wrench head 208 having an optional deeper notch 226 formed therein, with the deeper notch 226 extending radially outward from the center of the wrench head 208. The deeper notch 226 may extend along the handle or shank 202, in order to provide sufficient depth for the deeper notch 226. This notch 226 is configured to engage one wing of a conventional winged fastener, as used from time to time particularly in removing or securing a water supply line nut having such a winged configuration. It will be seen that any of the other wrench embodiments of the present invention may also be provided with such a fastener wing engagement notch, as desired.

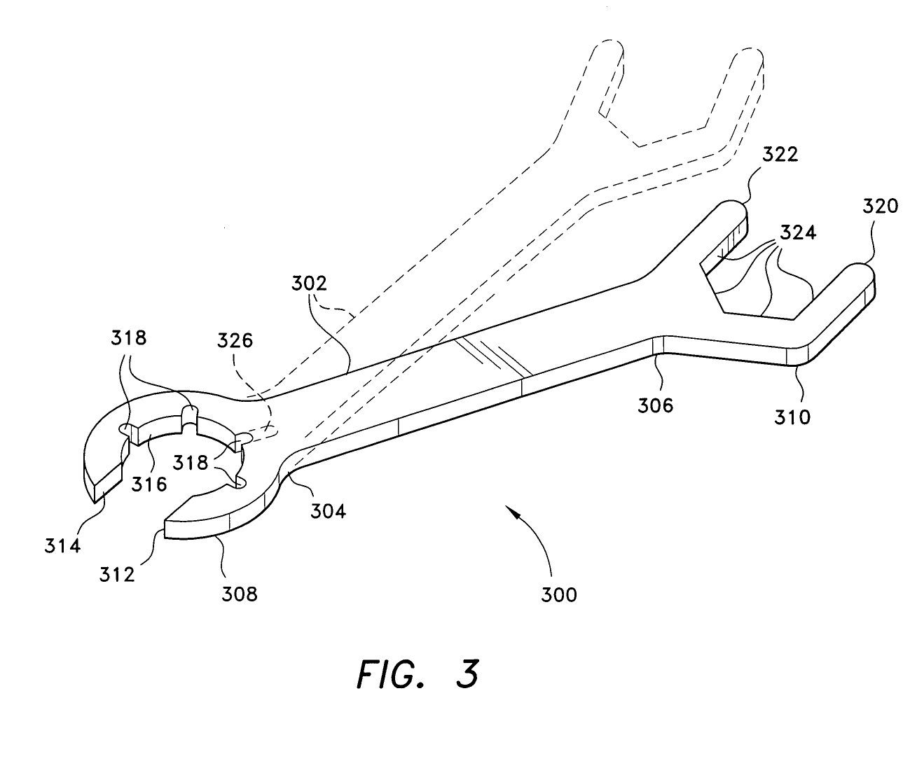

FIG. 3 illustrates another double ended wrench 300, somewhat similar to the wrench 100 of FIG. 1. The double open ended wrench 300 includes a shank 302 having opposite first and second ends, respectively 304 and 306, with each end having a wrench head, respectively 308 and 310, extending therefrom. The first wrench head 308 is configured similarly to the wrench heads 108 and 208 of the wrenches 100 and 200 respectively of FIGS. 1 and 2, i.e. having opposed first and second jaws 312 and 314 defining an opening therebetween for passing around a continuous length of material, with the wrench head 308 having a semicircular internal configuration 316 with a plurality of evenly and widely spaced, rounded notches 318 therein to engage the corresponding ribs of an externally ribbed ballcock valve retainer nut. The first wrench head 308 may also include a deeper notch 326 for engaging one wing of a winged fastener, if so desired.

The opposite, second end 306 of the wrench 300 has a second wrench head 310 extending therefrom, as noted further above. The second wrench head 310 is configured similarly to the second wrench head 110 of the wrench 100 of FIG. 1, i.e., having a pair of opposing jaws, respectively 320 and 322, defining an opening therebetween. However, the second wrench head 310 has a completely different internal configuration than that of the first wrench head 108, in that it is adapted to fit a conventional hexagonal threaded fitting. The internal configuration of the second wrench head 310 comprises four faces 324 spaced angularly at sixty degrees from one another, to fit precisely about a conventional hexagonal fastener.

FIG. 3 also clearly shows the option of offsetting the shank 302 of the wrench 300 relative to at least one of the wrench heads, e.g. the first head 308, with the offset embodiment shown in broken lines in FIG. 3. Alternatively, the wrench 300 (or any of the other wrenches of the present invention) may be formed in a flat, planar configuration, as shown by the solid line drawing of the wrench 300 of FIG. 3. Whether flat or having a planar offset, either or both of the wrench heads 308 and/or 310 of the wrench 300 may have an axially offset opening between their respective jaws, as is clearly shown in FIG. 3 by inspection of the drawing Fig. and as indicated in the wrench 100 of FIG. 1.

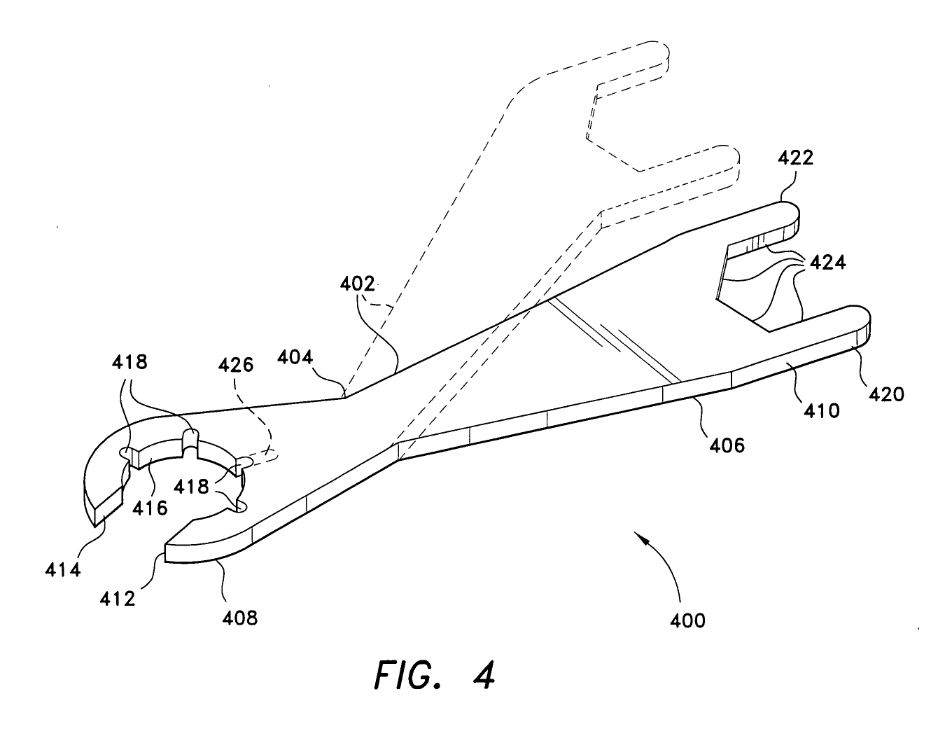

FIG. 4 illustrates yet another embodiment of the present ballcock valve assembly wrench, designated as wrench 400. The double open ended wrench 400 includes a shank 402 having opposite first and second ends, respectively 404 and 406, with each end having a wrench head, respectively 408 and 410, extending therefrom. The first wrench head 408 is configured similarly to the wrench heads 108, 208, and 308 of the wrenches 100, 200, and 300 respectively of FIGS. 1, 2, and 3, i.e. having opposed first and second jaws 412 and 414 defining an opening therebetween for passing around a continuous length of material, with the wrench head 408 having a semicircular internal configuration 416 with a plurality of evenly and widely spaced, rounded notches 418 therein to engage the corresponding ribs of an externally ribbed ballcock valve retainer nut. The first wrench head 408 may also include a deeper notch 426 for engaging one wing of a winged fastener, if so desired.

The opposite, second end 406 of the wrench 400 has a second wrench head 410 extending therefrom, as noted further above. The second wrench head 410 is configured similarly to the second wrench heads 110 and 310 of the wrenches 100 and 300 respectively of FIGS. 1 and 3, i.e., having a pair of opposing jaws, respectively 420 and 422, defining an opening therebetween. However, the second wrench head 410 has a completely different internal configuration than that of the first wrench head 108, in that it is adapted to fit a conventional hexagonal threaded fitting. The internal configuration of the second wrench head 410 comprises four faces 424 spaced angularly at sixty degrees from one another, to grip a conventional hexagonal fastener.

FIG. 4 also clearly shows the option of offsetting the shank 402 of the wrench 300 relative to the wrench heads, with the offset embodiment being shown in broken lines in FIG. 4. Alternatively, the wrench 400 (or any of the other wrench embodiments of the present invention) may be formed in a flat, planar configuration, as shown by the solid line drawing of the wrench 400 of FIG. 4. Whether flat or having a planar offset, either or both of the wrench heads 408 and/or 410 of the wrench 400 may have an axially offset opening between their respective jaws, as is clearly shown in FIG. 4 by inspection of the first wrench head 408 of the drawing Fig. and as indicated in the wrench 100 of FIG. 1. Alternatively, either or both of the wrench heads 408 and/or 410, or any of the other wrench heads of any of the other embodiments of the present invention, may be formed with no axial offset, as indicated by the second head 410.

The various wrench embodiments of the present invention may be formed of any suitable material which provides sufficient strength to accept the torque which may be applied by hand in loosening or securing the various fittings to which the present wrenches are adapted. No adjustability, ratcheting, or other relatively movable componentry is provided with any of the wrench embodiments of the present invention; each of the wrenches of the present invention is formed as a single, unitary, monolithic component, devoid of any relatively moving parts or components. The various wrench embodiments 100 through 400 of FIGS. 1 through 4 may be stamped from relatively thick sheet metal or metal plate, as is known in the art, or forged or otherwise formed as desired, to provide a durable and long lasting tool. However, other, softer materials, e.g. plastics, may be used in the manufacture of any of the embodiments of the present wrench, if so desired. Such plastic tools are somewhat less expensive to manufacture, and while not so durable as metal tools, may be provided as a component of an installation or repair kit for one time or limited use.

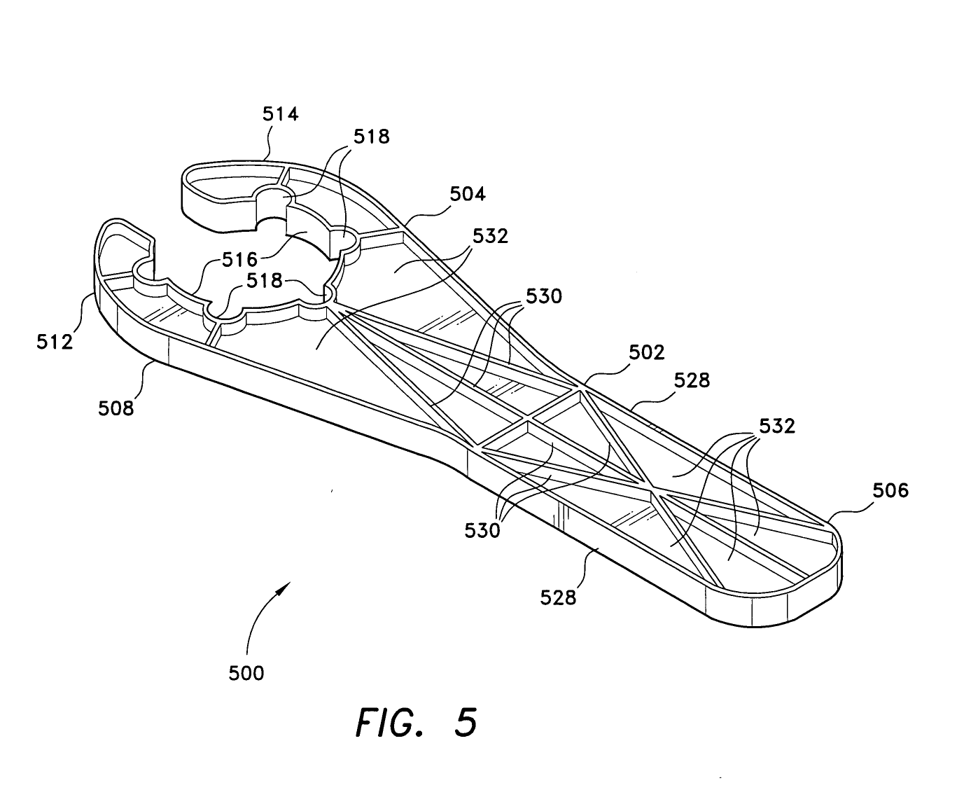

FIG. 5 provides an illustration of such a plastic wrench, designated as wrench 500. The wrench 500 has a single end configuration somewhat like that of the wrench 200 of FIG. 2, having a shank 502 with a first end 504 having a wrench head extending therefrom, and the opposite second end 506 forming a hand grip portion. The single wrench head 508 of the wrench 500 is configured similarly to the second wrench head 208 of the wrench 200 of FIG. 2, i.e., having two spaced apart jaws 512 and 514 defining a semicircular interior configuration 516 with a series of rounded notches 518 formed therein, adapted to fit precisely about the ribbed exterior of a conventional ballcock valve assembly retainer nut. The axis of the opening as defined by the jaws 512 and 514 may be aligned with the axis of the shank 502, as shown in FIG. 5, or may alternatively be axially offset, as in the ballcock valve wrench 100 of FIG. 1 or the wrench 200 of FIG. 2.

The primary difference between the wrench 500 of FIG. 5 and the wrench 200 of FIG. 2 is dictated by the materials of which the two wrenches are formed. The softer and weaker plastic material of which the wrench 500 is formed, requires additional stiffening and bracing to provide the required strength for the device. Accordingly, the wrench 500 is provided with a peripheral flange 528 defining the outline of the wrench 500, including its shank or handle 502 and unitary wrench head 508, with a series of intermediate flanges or ribs 530 provided along the length and width of the wrench 500 for further stiffening. Each of the spans or areas defined by the peripheral flange 528 and the intermediate flanges or ribs 530 includes a web 532 spanning the area thereacross, preferably centered between the opposite edges of the flanges and ribs 528 and 530. The complete configuration forms a unitary, monolithic structure providing sufficient strength to the plastic wrench 500 for a single use, or limited use, particularly in consideration of the relatively low torques which should be applied to plastic fittings and nuts commonly provided with ballcock valve installations.

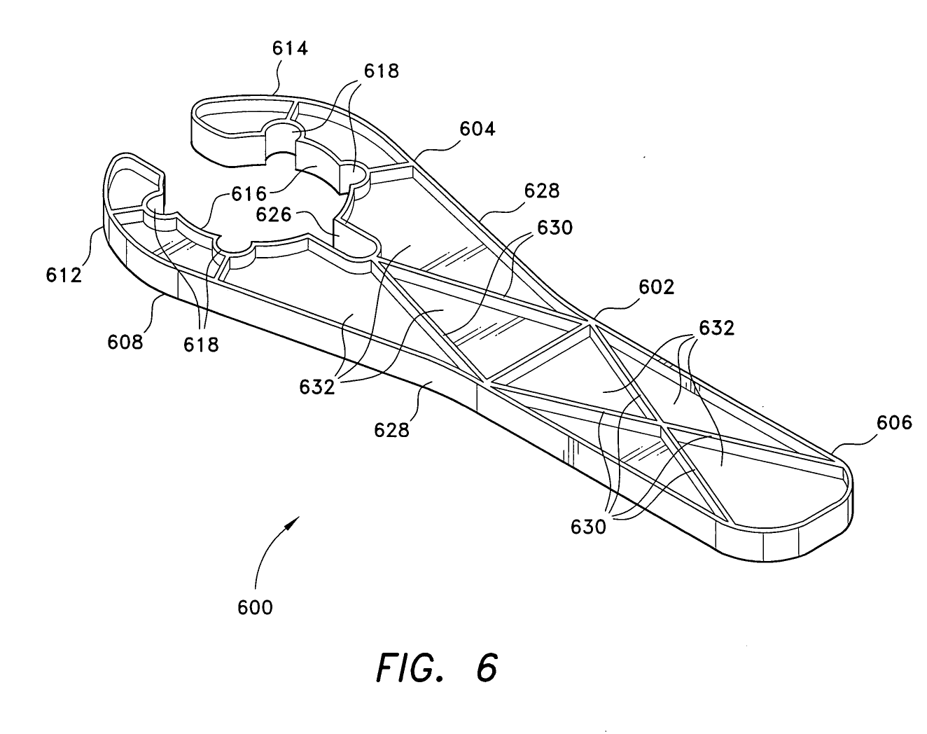

FIG. 6 of the drawings provides an illustration of still another embodiment of the present ballcock valve assembly wrench, designated as wrench 600. The plastic wrench 600 very closely resembles the plastic wrench 500 of FIG. 5, having a shank 602 with a first end 604 and an opposite second end 606, and a single wrench head 608 having two spaced apart jaws 612 and 614 defining a semicircular interior configuration 616 with a series of rounded notches 618 formed therein. A peripheral flange 628 defines the outline of the wrench 600, with a series of intermediate flanges or ribs 630 provided along the length and width of the wrench 600 for further stiffening. Webs 532 span the areas between the various ribs and flanges 628 and 630. However, the wrench 600 of FIG. 6 also includes a deeper notch 626 to accommodate and grip one wing of a winged fastener, e.g. a water supply line nut or even a ballcock valve retainer nut having such a winged configuration, similarly to the deeper notches 226, 326, and 426 respectively of the metal wrenches 200, 300, and 400 of FIGS. 2, 3, and 4.

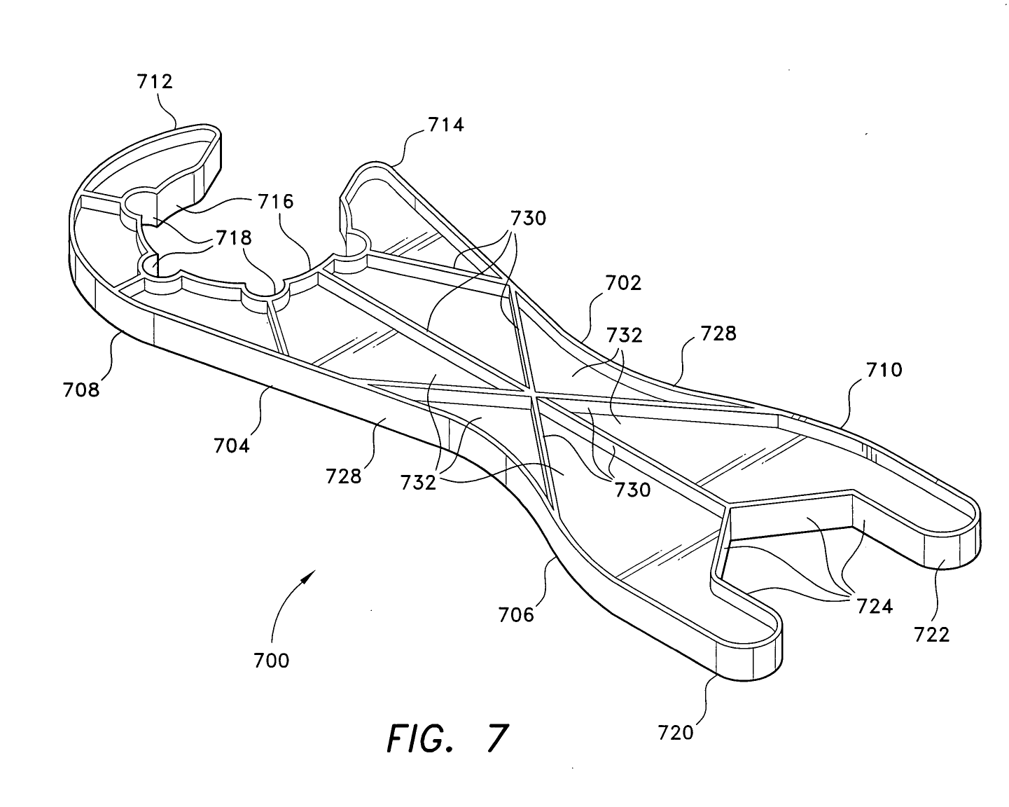

The plastic wrench 700 of FIG. 7 somewhat resembles the configuration of the wrench 400 of FIG. 4, in that the wrench 700 has a shank 702 with opposite first and second ends 704 and 706, with each end having a wrench head, respectively 708 and 710, extending therefrom. The first wrench head 708 has opposed first and second jaws 712 and 714, with the wrench head 708 having a semicircular internal configuration 716 with a plurality of evenly and widely spaced, rounded notches 718 therein. A deeper notch, not shown in the wrench 700, may also be provided.

The opposite, second end 706 of the wrench 700 has a second wrench head 710 extending therefrom, with the second wrench head 710 having a pair of opposing jaws, respectively 720 and 722, and a series of four faces 724 spaced angularly at sixty degrees from one another, to grip a conventional hexagonal fastener. The second wrench head 710 may be axially aligned with the length of the shank 702, i.e. without any axial offset, as shown, or may alternatively have some amount of axial offset, as desired. The first wrench head 708 may be axially offset, as shown in FIG. 7, or may alternatively be aligned axially with the shank portion 702, as in the plastic single wrench 500 embodiment of FIG. 5.

As in the case of the other plastic wrench embodiments 500 and 600 illustrated in FIGS. 5 and 6, the wrench 700 of FIG. 7 is provided with a peripheral flange 728 defining the outline of the wrench 700, including its shank or handle 702 and unitary wrench heads 708 and 710, with a series of intermediate flanges or ribs 730 provided along the length and width of the wrench 700 for further stiffening. Each of the spans or areas defined by the peripheral flange 728 and the intermediate flanges or ribs 730 includes a web 732 spanning the area thereacross, preferably centered between the opposite edges of the flanges and ribs 728 and 730. The complete configuration forms a unitary, monolithic structure providing sufficient strength to the plastic wrench 700 for a single use, or limited use, particularly in consideration of the relatively low torques which should be applied to plastic fittings and nuts commonly provided with ballcock valve installations.

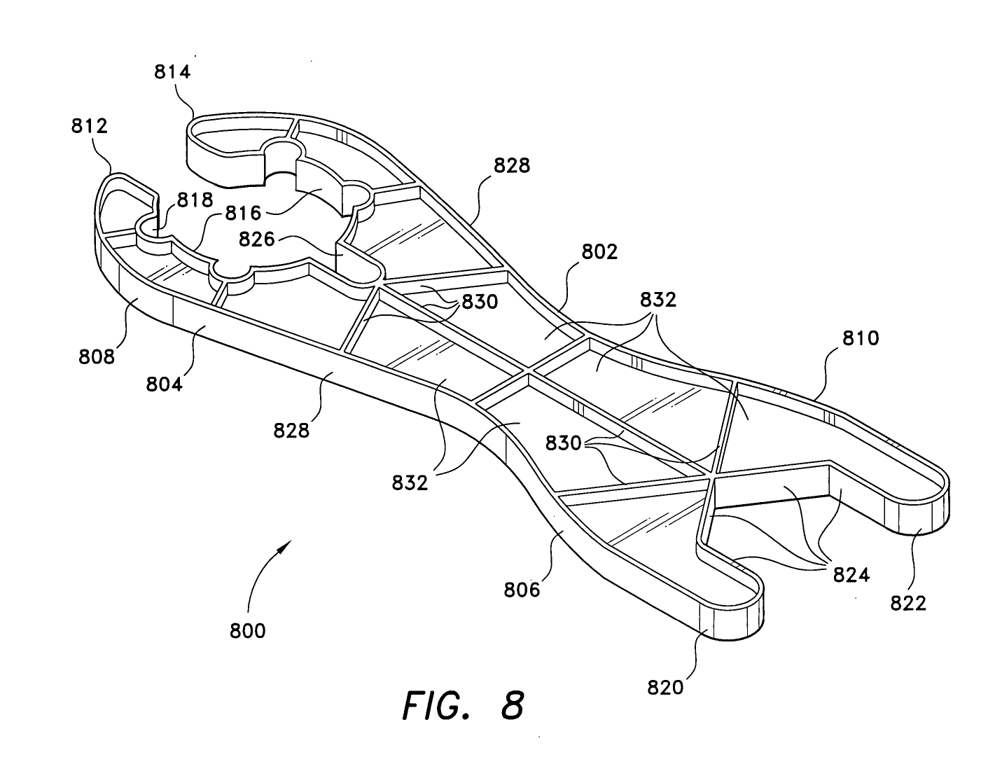

A further embodiment of the present ballcock valve assembly wrench is illustrated in FIG. 8 of the drawings, and designated as wrench 800. The plastic wrench 800 of FIG. 8 somewhat resembles the configuration of the wrench 700 of FIG. 7, with the wrench 800 having a shank 802 with opposite first and second ends 804 and 806, with each end having a wrench head, respectively 808 and 810, extending therefrom. The first wrench head 808 has opposed first and second jaws 812 and 814, with the wrench head 808 having a semicircular internal configuration 816 with a plurality of evenly and widely spaced, rounded notches 818 therein. A deeper notch 826 for gripping one wing of a winged fastener may also be provided, as shown.

The opposite, second end 806 of the wrench 800 has a second wrench head 810 extending therefrom, with the second wrench head 810 having a pair of opposing jaws, respectively 820 and 822, and a series of four faces 824 spaced angularly at sixty degrees from one another, to grip a conventional hexagonal fastener. The second wrench head 810 may be axially aligned with the length of the shank 802, i.e. without any axial offset, as shown, or may alternatively have some amount of axial offset, as desired. The first wrench head 808 may be aligned axially with the shank portion 802, as shown in FIG. 8, or may alternatively be axially offset, as in the plastic single wrench 700 embodiment of FIG. 7.

As in the case of the other plastic wrench embodiments 500, 600, and 700 illustrated in FIGS. 5, 6, and 7, the wrench 800 of FIG. 8 is provided with a peripheral flange 828 defining the outline of the wrench 800, including its shank or handle 802 and unitary wrench heads 808 and 810, with a series of intermediate flanges or ribs 830 provided along the length and width of the wrench 800 for further stiffening. Each of the spans or areas defined by the peripheral flange 828 and the intermediate flanges or ribs 830 includes a web 832 spanning the area thereacross, preferably centered between the opposite edges of the flanges and ribs 828 and 830. The complete configuration forms a unitary, monolithic structure providing sufficient strength to the plastic wrench 800 for a single use, or limited use, particularly in consideration of the relatively low torques which should be applied to plastic fittings and nuts commonly provided with ballcock valve installations.

In conclusion, the present toilet ballcock valve wrench invention provides a plumber or other worker with a single tool, or at most two tools, which provide superior versatility for manipulating the valve assembly retaining nut and/or supply line nuts conventionally found in such installations. Using the present tools, the worker need not resort to adjustable wrenches and the like which provide only an approximate fit to the part and result in damage to the part due to rounding the corners or ribs of the fastener. Moreover, the combination of two wrenches having different configurations in a single tool, as is the case in many of the embodiments of the present invention, serves to reduce the number of tools which the worker must carry to the jobsite and keep track of to assure their recovery when the work is completed, thereby simplifying the logistics of the repair.

While many of the wrench embodiments of the present invention are formed of a durable material such as metal, the present wrenches may be formed of a less durable material for single or limited use, and may be provided as an inexpensive alternative to the homeowner who has occasion to make only a single repair or installation. Such a plastic wrench may be provided as a component of a repair kit for such ballcock valves, thereby greatly simplifying the task of purchasing and gathering all of the parts, tools, and equipment for the task. This will be a great advantage to the homeowner or amateur repairman, as such provision of all of the components and tools in a single kit, greatly reduces the time and thought required to plan the installation or repair of a ballcock valve assembly. Accordingly, the present invention will find favor with both professional plumbers and repair persons and amateur do-it-yourselfers and homeowners who have occasion to perform such installations and repairs.

It is to be understood that the present invention is not limited to the embodiments described above, but encompasses any and all embodiments within the scope of the following claims.

1. A toilet ballcock valve wrench, comprising:
a narrow, elongate shank having a first end and a second end opposite the first end; and
a pair of opposing jaws forming a first open-end wrench head at the first end of the shank, the wrench head defining a semicircular internal configuration having a plurality of evenly spaced, widely separated, rounded notches defined therein, the wrench head being adapted for gripping a nut securing a ballcock valve assembly, the notches being dimensioned and configured for conforming to ribs disposed on an outer face of the nut.

2. The toilet ballcock valve wrench according to claim 1, further including a pair of opposing jaws forming a second open-end wrench head at the second end of said shank, the second wrench head defining four sides of a hexagonal opening adapted for gripping a hexagonal nut of the ballcock valve assembly.

3. The toilet ballcock valve wrench according to claim 2, wherein at least one said wrench head is axially offset from said shank.

4. The toilet ballcock valve wrench according to claim 2, wherein at least one said wrench head has a planar offset from said shank.

5. The toilet ballcock valve wrench according to claim 2, wherein said second open-end wrench head has a smaller span than said first open-end wrench head.

6. The toilet ballcock valve wrench according to claim 1, further including a deep, fastener wing engagement notch defined within the wrench head.

7. The toilet ballcock valve wrench according to claim 1, wherein said wrench head and said shank are formed of metal as a single, unitary, monolithic structure devoid of relatively moving components.

8. The toilet ballcock valve wrench according to claim 1, wherein said wrench head and said shank are formed of plastic as a single, unitary, monolithic structure devoid of relatively moving components.

9. The toilet ballcock valve wrench according to claim 8, further including a plurality of ribs having a corresponding plurality of webs centrally disposed therebetween, and forming said plastic wrench head and shank.

10. A toilet ballcock valve wrench, comprising:
a narrow, elongate shank having a first end and a second end opposite the first end;
a pair of opposing jaws forming a first open-end wrench head at the first end of the shank, the wrench head defining a semicircular internal configuration having a plurality of evenly spaced, widely separated, rounded notches defined therein, the wrench head being adapted for gripping a nut securing a ballcock valve assembly, the notches being dimensioned and configured for conforming to ribs disposed on an outer face of the nut; and
a pair of opposing jaws forming a second open-end wrench head at the second end of said shank, the second wrench head defining four sides of a hexagonal opening adapted for gripping a hexagonal nut of the ballcock valve assembly.

11. The toilet ballcock valve wrench according to claim 10, wherein at least one said wrench head is axially offset from said shank.

12. The toilet ballcock valve wrench according to claim 10, wherein at least one said wrench head has a planar offset from said shank.

13. The toilet ballcock valve wrench according to claim 10, wherein said second open-end wrench head has a smaller span than said first open-end wrench head.

14. The toilet ballcock valve wrench according to claim 10, further including a deep, fastener wing engagement notch defined within the wrench head.

15. The toilet ballcock valve wrench according to claim 10, wherein said wrench head and said shank are formed of metal as a single, unitary, monolithic structure devoid of relatively moving components.

16. The toilet ballcock valve wrench according to claim 10, wherein said wrench head and said shank are formed of plastic as a single, unitary, monolithic structure devoid of relatively moving components.

17. The toilet ballcock valve wrench according to claim 16, further including a plurality of ribs having a corresponding plurality of webs centrally disposed therebetween, and forming said plastic wrench head and shank.

18. A toilet ballcock valve wrench, comprising:
a narrow, elongate shank having a first end and a second end opposite the first end;
a pair of opposing jaws forming a first open-end wrench head at the first end of the shank, the wrench head defining a semicircular internal configuration having a plurality of evenly spaced, widely separated, rounded notches defined therein, the wrench head being adapted for gripping a nut securing a ballcock valve assembly, the notches being dimensioned and configured for conforming to ribs disposed on an outer face of the nut;
a pair of opposing jaws forming a second open-end wrench head at the second end of said shank, the second wrench head defining four sides of a hexagonal opening adapted for gripping a hexagonal nut of the ballcock valve assembly, at least one said wrench head being axially offset and having a planar offset from said shank; and
a deep, fastener wing engagement notch defined within first the wrench head;
wherein said wrench head and said shank comprise a single, unitary, monolithic structure devoid of relatively moving components, formed of materials selected from the group consisting of metal and plastic.

19. The toilet ballcock valve wrench according to claim 18, wherein said second open-end wrench head has a smaller span than said first open-end wrench head.
